(19) United States
(12) Patent Application Publication
(10) Pub. No.: US 2026/0252937 A1
(43) Pub. Date: Aug. 27, 2026

(54) EVALUATING ACTION OF A HAMILTONIAN ON A SUBSPACE IN A MATRIX-FREE MANNER

(71) Applicant: International Business Machines Corporation, Armonk, NY (US)

(72) Inventors: Paul Nation, Yorktown Heights, NY (US); Hwajung Kang, Yorktown Heights, NY (US)

(21) Appl. No.: 19/065,808

(22) Filed: Feb. 27, 2025

(51) Int. Cl. G06N 10/60; G06F 17/16

(52) U.S. Cl. CPC G06N 10/60; G06F 17/16

(57) ABSTRACT

A method, system and computer program product for computing nonzero elements of a Hamiltonian in a matrix-free manner. A set of bit-strings which defines an action being performed by a qubit Hamiltonian on a subspace spanned by the set of bit-strings described by a vector is received from a quantum computer. Each of the bit-strings includes a set of operators defining measurement outcomes for a set of qubits. Such operators may include projection operators and/or ladder operators. Additionally, each of the bit-strings has one nonzero element per row of a represented matrix. A nonzero element in a bit-string corresponding to a column of the represented matrix is identified by flipping bits in a bit-string corresponding to a row of the represented matrix on a qubit where an operator is non-diagonal. A numerical value for the identified nonzero element is then obtained from the row and column bit-strings.

### TECHNICAL FIELD

The present disclosure relates generally to quantum computing, and more particularly to evaluating the action of Hamiltonians in quantum computing on a subspace, such as a subspace of the full Hilbert space, in a matrix-free manner.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

In quantum computing, a Hamiltonian (represented by the symbol “H”) is a mathematical operator that represents the total energy of a quantum system, such as the sum of kinetic and potential energies within the quantum system. That is, the Hamiltonian calculates how the quantum system will change over time by defining its energy state. Determining the Hamiltonian of the quantum system is crucial for understanding how qubits (fundamental units of information in quantum computing) evolve and interact within a quantum circuit (collection of interconnected quantum gates, which are used to carry out unitary transformations on qubits).

The Hamiltonian is expressed as a matrix in quantum computing, which consists of operators representing both the kinetic energy (“T”) and potential energy (“V”) of the system, where H=T+V. An operator refers to a mathematical object that represents a transformation applied to a quantum state, such as performing a calculation or manipulation on the qubit(s) by changing their superposition and phase to describe a physical property, such as position or momentum, within the quantum system.

Typically, the Hamiltonian is expressed using Pauli operators. By using combinations of Pauli operators (e.g., X, Y, and Z), the quantum system's Hamiltonian can be represented in a manner that is easily understood and implemented on the quantum system. Pauli operators, such as the X, Y, and Z operators, are a set of operators used in quantum mechanics that represent measurements of a qubit's spin along the x, y, and z-axis, respectively. Each Pauli operator is represented by a 2×2 matrix.

Such an expressed Hamiltonian is utilized in various algorithms. For example, Pauli matrices are used to represent the basic building blocks of fermionic operators (mathematical operators used in quantum mechanics to represent the creation or annihilation of fermionic particles, which are particles that obey the Pauli exclusion principle, referring to having only one fermion occupy a given quantum state at a time) within a qubit system allowing for the translation of a fermionic Hamiltonian (mathematical operator used in quantum mechanics to describe the energy of a system composed of fermionic particles) into a qubit Hamiltonian (outlining how the qubit's quantum state evolves over time) through a specific mapping scheme, such as the Jordan-Wigner transformation. Unfortunately, by utilizing only Pauli operators in such a translation, an unfavorable overhead results, such as in the Jordan-Wigner mapping due to the significant number of operator terms. Furthermore, by operating on Hamiltonians using Pauli operators, computationally expensive matrix operations are required.

If, however, the action of Hamiltonians in quantum computing could be evaluated in a matrix-free manner, then such computationally expensive matrix operations could be lessened or avoided in algorithms using the Hamiltonian, such as eigensolving, matrix-exponentiation, and iterative linear solution methods (e.g., Harrow-Hassidim-Lloyd algorithm).

### SUMMARY

In one embodiment of the present disclosure, a method for computing nonzero elements of a Hamiltonian in a matrix-free manner comprises receiving a set of bit-strings from a quantum computer defining an action being performed by a qubit Hamiltonian on a subspace spanned by the set of bit-strings described by a vector, where each of the set of bit-strings comprises a set of operators defining measurement outcomes for a set of qubits, and where each of the set of bit-strings has one nonzero element per row of a represented matrix. The method further comprises identifying a nonzero element in a bit-string corresponding to a column of the represented matrix by flipping bits in a bit-string corresponding to a row of the represented matrix on a qubit where an operator is non-diagonal. The method additionally comprises obtaining a numerical value for the identified nonzero element from the row and column bit-strings.

Furthermore, in one embodiment of the present disclosure, the set of operators comprises projection operators and ladder operators.

Additionally, in one embodiment of the present disclosure, the set of operators comprises Pauli operators.

Furthermore, in one embodiment of the present disclosure, the numerical value for the identified nonzero element is obtained from the row and column bit-strings and 2×2 matrices for operators in the row and column bit-strings.

Additionally, in one embodiment of the present disclosure, the numerical value for the identified nonzero element is used in mapping Fermionic operators to qubit operators.

Furthermore, in one embodiment of the present disclosure, the action of the qubit Hamiltonian is performed on the subspace of a full Hilbert space.

Additionally, in one embodiment of the present disclosure, a dimension of the vector is equal to the subspace of the full Hilbert space.

Furthermore, in one embodiment of the present disclosure, the vector is a matrix-vector product.

Additionally, in one embodiment of the present disclosure, the method further comprises sorting the set of bit-strings in the subspace into bins based on an integer value of a sub-string of the set of bit-strings.

Furthermore, in one embodiment of the present disclosure, the method additionally comprises classifying each term in the qubit Hamiltonian to one of a plurality of designated non-diagonal pattern groups and sorting the Hamiltonian terms based on the plurality of designated non-diagonal pattern groups.

Additionally, in one embodiment of the present disclosure, the method further comprises permutating rows and columns of a sparse matrix of subspace data of the subspace into a band matrix form.

Other forms of the embodiments of the method described above are in a system and in a computer program product.

Accordingly, embodiments of the present disclosure compute nonzero elements of a Hamiltonian in a matrix-free manner, where the explicit formation of a matrix representation is avoided along with the associated floating-point calculations.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for evaluating the action of a Hamiltonian on a subspace in a matrix-free manner in accordance with an embodiment of the present disclosure;

FIG. 3 illustrates a subspace of k-elements in the Hilbert space in accordance with an embodiment of the present disclosure;

FIG. 4 illustrates an efficient procedure to reduce the cost of the subspace search in accordance with an embodiment of the present disclosure;

FIG. 5 illustrates reducing the lookup cost by classifying each term in the Hamiltonian to a specific non-diagonal group and sorting the Hamiltonian terms based on the designated non-diagonal groups in accordance with an embodiment of the present disclosure;

FIG. 6 illustrates flipping the bits in a bit-string corresponding to a row of the represented matrix on a qubit where an operator is non-diagonal to identify a nonzero element in a bit-string corresponding to a column of the represented matrix in accordance with an embodiment of the present disclosure;

FIG. 7 illustrates obtaining the numerical value of the nonzero element from the row and column bit-strings and the 2×2 matrices for the operators in the Pauli string in accordance with an embodiment of the present disclosure;

FIG. 8 illustrates matrix permutation that allows for partitioning of the subspace into smaller sub-components that can be distributed for massively-parallel computations in accordance with an embodiment of the present disclosure;

FIG. 9 illustrates an embodiment of the present disclosure of the hardware configuration of the classical computer which is representative of a hardware environment for practicing the present disclosure; and

FIG. 10 is a flowchart of a method for evaluating the action of a Hamiltonian on a subspace, such as a subspace of the full Hilbert space, in a matrix-free manner in accordance with an embodiment of the present disclosure.

### DETAILED DESCRIPTION

In one embodiment of the present disclosure, a method for computing nonzero elements of a Hamiltonian in a matrix-free manner comprises receiving a set of bit-strings from a quantum computer defining an action being performed by a qubit Hamiltonian on a subspace spanned by the set of bit-strings described by a vector, where each of the set of bit-strings comprises a set of operators defining measurement outcomes for a set of qubits, and where each of the set of bit-strings has one nonzero element per row of a represented matrix. The method further comprises identifying a nonzero element in a bit-string corresponding to a column of the represented matrix by flipping bits in a bit-string corresponding to a row of the represented matrix on a qubit where an operator is non-diagonal. The method additionally comprises obtaining a numerical value for the identified nonzero element from the row and column bit-strings.

In this manner, nonzero elements of a Hamiltonian are computed in a matrix-free manner, where the explicit formation of a matrix representation is avoided along with the associated floating-point calculations.

Furthermore, in one embodiment of the present disclosure, the set of operators comprises projection operators and ladder operators.

In this manner, by incorporating projection operators and ladder operators, such as for Fermionic and Bosonic Hamiltonian descriptions, the Fermionic to qubit operator transformations can occur with a reduced number of terms in comparison to standard Pauli transformations.

Additionally, in one embodiment of the present disclosure, the set of operators comprises Pauli operators.

In this manner, Pauli operators may be utilized in combination with projection operators and ladder operators, where Pauli operators offer a convenient way to express an arbitrary Hamiltonian for quantum computation.

Furthermore, in one embodiment of the present disclosure, the numerical value for the identified nonzero element is obtained from the row and column bit-strings and 2×2 matrices for operators in the row and column bit-strings.

In this manner, the numerical evaluation of the Hamiltonian within the subspace can be computed classically.

Additionally, in one embodiment of the present disclosure, the numerical value for the identified nonzero element is used in mapping Fermionic operators to qubit operators.

In this manner, the number of terms used in the mapping from Fermion to qubit operators, such as via the Jordan-Wigner mapping, can be greatly reduced.

Furthermore, in one embodiment of the present disclosure, the action of the qubit Hamiltonian is performed on the subspace of a full Hilbert space.

In this manner, the action of the Hamiltonian can be evaluated in a matrix-free manner.

Additionally, in one embodiment of the present disclosure, a dimension of the vector is equal to the subspace of the full Hilbert space.

In this manner, the action of the Hamiltonian can be evaluated in a matrix-free manner.

Furthermore, in one embodiment of the present disclosure, the vector is a matrix-vector product.

In this manner, the action of the Hamiltonian can be evaluated in a matrix-free manner.

Additionally, in one embodiment of the present disclosure, the method further comprises sorting the set of bit-strings in the subspace into bins based on an integer value of a sub-string of the set of bit-strings.

In this manner, the computational cost for performing subspace searches is reduced.

Furthermore, in one embodiment of the present disclosure, the method additionally comprises classifying each term in the qubit Hamiltonian to one of a plurality of designated non-diagonal pattern groups and sorting the Hamiltonian terms based on the plurality of designated non-diagonal pattern groups.

In this manner, the subspace lookup procedure can be avoided.

Additionally, in one embodiment of the present disclosure, the method further comprises permutating rows and columns of a sparse matrix of subspace data of the subspace into a band matrix form.

In this manner, sparse matrix operations can be accelerated by minimizing the bandwidth.

Other forms of the embodiments of the method described above are in a system and in a computer program product.

As stated above, in quantum computing, a Hamiltonian (represented by the symbol “H”) is a mathematical operator that represents the total energy of a quantum system, such as the sum of kinetic and potential energies within the quantum system. That is, the Hamiltonian calculates how the quantum system will change over time by defining its energy state. Determining the Hamiltonian of the quantum system is crucial for understanding how qubits (fundamental units of information in quantum computing) evolve and interact within a quantum circuit (collection of interconnected quantum gates, which are used to carry out unitary transformations on qubits).

The Hamiltonian is expressed as a matrix in quantum computing, which consists of operators representing both the kinetic energy (“T”) and potential energy (“V”) of the system, where H=T+V. An operator refers to a mathematical object that represents a transformation applied to a quantum state, such as performing a calculation or manipulation on the qubit(s) by changing their superposition and phase to describe a physical property, such as position or momentum, within the quantum system.

Typically, the Hamiltonian is expressed using Pauli operators. By using combinations of Pauli operators (e.g., X, Y, and Z), the quantum system's Hamiltonian can be represented in a manner that is easily understood and implemented on the quantum system. Pauli operators, such as the X, Y, and Z operators, are a set of operators used in quantum mechanics that represent measurements of a qubit's spin along the x, y, and z-axis, respectively. Each Pauli operator is represented by a 2×2 matrix.

Such an expressed Hamiltonian is utilized in various algorithms. For example, Pauli matrices are used to represent the basic building blocks of fermionic operators (mathematical operators used in quantum mechanics to represent the creation or annihilation of fermionic particles, which are particles that obey the Pauli exclusion principle, referring to having only one fermion occupy a given quantum state at a time) within a qubit system allowing for the translation of a fermionic Hamiltonian (mathematical operator used in quantum mechanics to describe the energy of a system composed of fermionic particles) into a qubit Hamiltonian (outlining how the qubit's quantum state evolves over time) through a specific mapping scheme, such as the Jordan-Wigner transformation. Unfortunately, by utilizing only Pauli operators in such a translation, an unfavorable overhead results, such as in the Jordan-Wigner mapping due to the significant number of operator terms. Furthermore, by operating on Hamiltonians using Pauli operators, computationally expensive matrix operations are required.

If, however, the action of Hamiltonians in quantum computing could be evaluated in a matrix-free manner, then such computationally expensive matrix operations could be lessened or avoided in algorithms using the Hamiltonian, such as eigensolving, matrix-exponentiation, and iterative linear solution methods (e.g., Harrow-Hassidim-Lloyd algorithm).

The embodiments of the present disclosure provide the means for evaluating the action of a Hamiltonian operator on a vector (e.g., matrix-vector product) equal to the subspace of the full Hilbert space. The full Hilbert space, as used herein, refers to the Hilbert space (vector space equipped with an inner product operation, which allows lengths and angles to be defined) with an infinite number of dimensions thereby representing an infinite range of possible states within the quantum system. A subspace, as used herein, refers to a subset of the full Hilbert space which itself forms a smaller Hilbert space. Operators besides the Pauli operators are utilized in evaluating the action of Hamiltonians so as to avoid expensive matrix operations, such as in algorithms using the Hamiltonian. For example, the operator framework of the present disclosure incorporates projection operators (e.g., 0, 1) and ladder operators (e.g., +, −) for both Fermionic and Bosonic Hamiltonian descriptions. A projection operator, as used herein, refers to a mathematical operator that effectively “projects” a quantum state onto a specific subspace thereby extracting the component of the state that belongs to that subspace. A ladder operator, as used herein, is an operator that, when applied to a quantum state, creates a new state with a slightly higher or lower eigenvalue. A Fermionic Hamiltonian description, as used herein, refers to a mathematical description of a quantum system composed of fermions using operators that obey anticommutation relations thereby representing the total energy of the quantum system while accounting for the behavior of fermions, including the Pauli Exclusion Principle where two fermions cannot occupy the same quantum state simultaneously. A Bosonic Hamiltonian description, as used herein, refers to a mathematical representation of a quantum system composed of bosons. As a result of incorporating projection operators (e.g., 0, 1) and ladder operators (e.g., +, −) for both Fermionic and Bosonic Hamiltonian descriptions, the Fermionic to qubit operator transformations are defined using a reduced number of terms in comparison to standard Pauli transformations. For example, pairs of ladder operators for Fermionic modes (“fermionic mode” refers to a single quantum state that can be occupied by only one fermion) are expressed in terms of projection operators resulting in a reduced number of operator strings when transforming to qubit operators. Such a transformation is referred to herein as the “extended” transformation. Another type of transformation (referred to herein as the “computational” transformation) is where the Fermionic operators (e.g., creation and annihilation operators to create or remove a fermion from the quantum system) are represented using projection operators and ladder operators that transform directly into their qubit equivalents. In one embodiment, in such computational transformations, the number of Fermionic terms is equal to the final number of operator strings in the qubit case. As a result, there is a reduction in the number of terms, such as Pauli terms, utilized. In one embodiment, the computational transformations can be evaluated classically when, for example, a quantum computer is used to sample a subset of the Hilbert space forming a subspace, and the numerical evaluation of the Hamiltonian within this subspace is computed classically as discussed herein.

Furthermore, embodiments of the present disclosure evaluate the Hamiltonians using operators beyond the Pauli operators as discussed above on a classical computer by computing the nonzero elements of the Hamiltonian in a matrix-free manner. In one embodiment, a set of bit-strings from the quantum computer which define an action being performed by a qubit Hamiltonian (a mathematical operator that represents the total energy of a single qubit) on a subspace spanned by the set of bit-strings described by a vector is received. That is, the action of a subspace Hamiltonian is applied to a vector, which may be equal to the subspace of the full Hilbert space, in a matrix-free manner thereby allowing for efficient computation of quantities, such as the eigenspectrum of the Hamiltonian confined to the subspace. A bit-string, as used herein, refers to a sequence of computational basis states of the qubits, where each qubit can be in a superposition state allowing the string to represent a vast range of possibilities. In one embodiment, each of the bit-strings includes a set of operators defining measurement outcomes for a set of qubits. Such operators may include projection operators and/or ladder operators. Furthermore, in one embodiment, such operators include Pauli operators in combination with the projection operators and/or ladder operators. Additionally, in one embodiment, each of the bit-strings has one nonzero element per row of a represented matrix. A represented matrix, as used herein, refers to a matrix that is representative of the action of the qubit Hamiltonian on the subspace. A nonzero element in a bit-string corresponding to a column of the represented matrix is identified by flipping bits in a bit-string corresponding to a row of the represented matrix on a qubit where an operator is non-diagonal. An operator is considered “non-diagonal” when its matrix representation has nonzero entries outside of the main diagonal. A numerical value for the identified nonzero element is then obtained from the row and column bit-strings. In this manner, nonzero elements of a Hamiltonian can be computed in a matrix-free manner, where the explicit formation of a matrix representation is avoided along with the associated floating-point calculations. Using the computational transformation from Fermions, such matrix-free techniques of the present disclosure can be applied to both Fermion and Bosonic problems in a unified manner.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

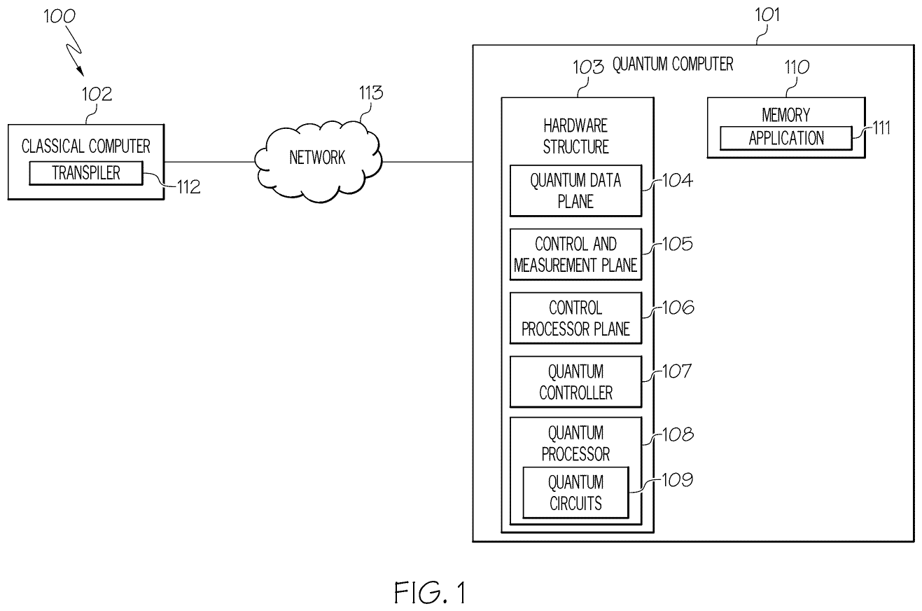

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to evaluate the action of a Hamiltonian on a subspace in a matrix-free manner.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

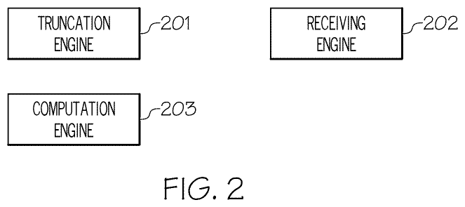

In one embodiment, memory 110 stores an application 111 that may be configured to implement one or more of the methods described herein in accordance with one or more embodiments. For example, application 111 may implement a program for evaluating the action of a Hamiltonian on a subspace in a matrix-free manner as discussed further below in connection with FIGS. 2-8 and 10. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

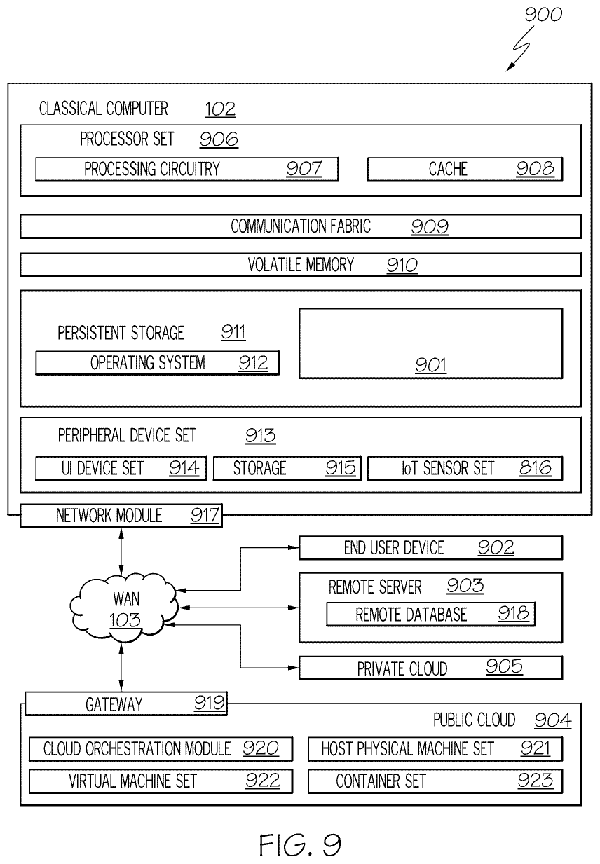

Furthermore, classical computer 102 is configured to evaluate the action of a Hamiltonian on a subspace in a matrix-free manner as discussed further below in connection with FIGS. 2-8 and 10. A description of the software components of classical computer 102 is provided below in connection with FIG. 2 and a description of the hardware configuration of classical computer 102 is provided further below in connection with FIG. 9.

System 100 is not to be limited in scope to any one particular network architecture. System 100 may include any number of quantum computers 101, classical computers 102, and networks 113.

A discussion regarding the software components used by classical computer 102 for evaluating the action of a Hamiltonian on a subspace in a matrix-free manner is provided below in connection with FIG. 2.

FIG. 2 is a diagram of the software components of classical computer 102 (FIG. 1) for evaluating the action of a Hamiltonian on a subspace in a matrix-free manner in accordance with an embodiment of the present disclosure.

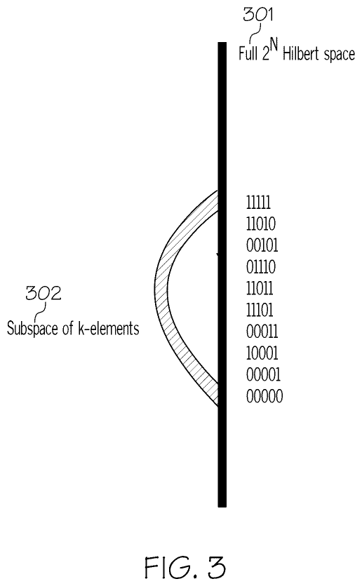

Referring to FIG. 2, in conjunction with FIG. 1, classical computer 102 includes truncation engine 201 configured to truncate the Hamiltonian into an observed subspace of bit-strings as illustrated in FIG. 3. A subspace, as used herein, refers to a subset of the full Hilbert space which itself forms a smaller Hilbert space. The full Hilbert space, as used herein, refers to the Hilbert space (vector space equipped with an inner product operation, which allows lengths and angles to be defined) with an infinite number of dimensions thereby representing an infinite range of possible states within the quantum system.

FIG. 3 illustrates a subspace of k-elements in the Hilbert space in accordance with an embodiment of the present disclosure.

Referring to FIG. 3, the Hamiltonian is truncated into an observed subspace of bit-strings from the Hilbert space 301 of 2^{N} qubits, where N is a positive integer number, where each bit-string represents a unique k-element subset, resulting in a subspace 302 of k-elements.

Due to the size of the full Hilbert space, it may be impractical to solve the problem over the full Hilbert space. As a result, the problem may be solved over a polynomial subspace (e.g., subspace 302).

In one embodiment, quantum circuit 109 samples the k-elements of subspace 302 (polynomial set of bit-strings) to define the action being performed by a qubit Hamiltonian on subspace 302 spanned by the set of bit-strings described by a vector.

In one embodiment, a bit-string of length k can be used to represent a subset of a k-element set, with each bit position corresponds to an element and a ‘l’ indicates that the element is included in the subset.

In one embodiment, the Hamiltonian is truncated into a subspace by selecting a subset of k-elements from the full Hilbert space and then projecting the Hamiltonian onto that subspace.

In one embodiment, each of the bit-strings includes a set of operators defining measurement outcomes for a set of qubits. In one embodiment, each bit in the bit-string corresponds to the result of a measurement on a single qubit with “0” or “1” representing the measurement outcome based on the specific operator used.

In one embodiment, Pauli operators (e.g., X, Y, and Z) are used to represent the basis for measuring a qubit. When multiple Pauli operators are combined using tensor products, they define measurement outcomes for a set of qubits which translates directly to a set of bit-strings returned from quantum computer 101 after measurement. In one embodiment, each bit in the bit-string corresponds to the result of a Pauli measurement on a single qubit with a “0” or a “1” representing the measurement outcome based on the specific Pauli measurement used.

In one embodiment, each Pauli operator (e.g., X, Y, and Z) represents a different way to measure a single qubit allowing information about its state along a specific axis in the Bloch sphere to be extracted. When multiple qubits are measured, Pauli operators are combined using tensor products creating a Pauli string that defines the combined measurement outcome for all qubits involved.

In one embodiment, the result of the Pauli measurement on each qubit is either “0” or “1” so the entire set of Pauli measurements on multiple qubits translates to a bit-string where each bit in the bit-string represents the measurement outcome of a single qubit.

Returning to FIG. 2, classical computer 102 further includes receiving engine 202 configured to receive a set of bit-strings from quantum computer 101 defining an action being performed by a qubit Hamiltonian on the subspace (observed subspace of bit-strings discussed above) (e.g., subspace 302) spanned by the set of bit-strings described by a vector. That is, the action of a subspace Hamiltonian is applied to a vector, which may be equal to the subspace (e.g., subspace 302) of the full Hilbert space (e.g., Hilbert space 301), in a matrix-free manner thereby allowing for efficient computation of quantities, such as the eigenspectrum of the Hamiltonian confined to the subspace.

A qubit Hamiltonian, as used herein, refers to a mathematical operator that represents the total energy of a single qubit. In one embodiment, the vector (e.g., matrix-vector product) is equal to the subspace (e.g., subspace 302) of the full Hilbert space (e.g., Hilbert space 301). In one embodiment, the vector is represented as a column matrix (one column and as many rows as the number of elements in the vector), which is multiplied by a matrix, where the matrix has the same number of columns as the vector has elements.

In one embodiment, the subspace of bit-strings (e.g., subspace 302) is described by the vector where each element in the vector corresponds to the value of the bit in a bit-string in the subspace (e.g., subspace 302).

An example of a set of bit-strings defining an action being performed by a qubit Hamiltonian on a subspace (e.g., subspace 302) spanned by the set of bit-strings is shown below:

H=IZZI+IXZZ−IYXZ . . .

where Pauli operator X represents a bit flip operation, Pauli operator Y performs a combination of a bit flip and a phase flip on a qubit, Pauli operator Z applies a phase flip to a qubit, leaving the state |0> unchanged and adding a negative phase to |1>, and Pauli operator I is the identity operator, which performs the “do nothing” operation that leaves the quantum state unchanged.

While the foregoing illustrates a Pauli string (bit-string that includes a set of Pauli operators), such a string may include a set of operators, such as projection operators and/or ladder operators, defining the measurement outcomes for a set of qubits. In one embodiment, the set of operators may also include Pauli operators in combination with projection operators and/or ladder operators.

In one embodiment, each bit-string in the received set of bit-strings has one nonzero element per row of a represented matrix. A represented matrix, as used herein, refers to a matrix that is representative of the action of the qubit Hamiltonian on the subspace (e.g., subspace 302).

Furthermore, classical computer 102 includes computation engine 203 configured to identify a nonzero element in a bit-string corresponding to a column of the represented matrix (“column bit-string”) by flipping bits in a bit-string corresponding to a row of the represented matrix (“row bit-string”) on a qubit where an operator is non-diagonal, where the column and row bit-strings are included in the received set of bit-strings.

In one embodiment, computation engine 203 performs a search in subspace 302 to identify the column bit-string in subspace 302. In one embodiment, computation engine 203 iterates through subspace 302 to identify a column bit-string in subspace 302.

In one embodiment, computation engine 203 groups the bit-strings of subspace 302 into “bins” that are determined by the integer value of a sub-string of a variable width (referred to herein as the “bin_width”).

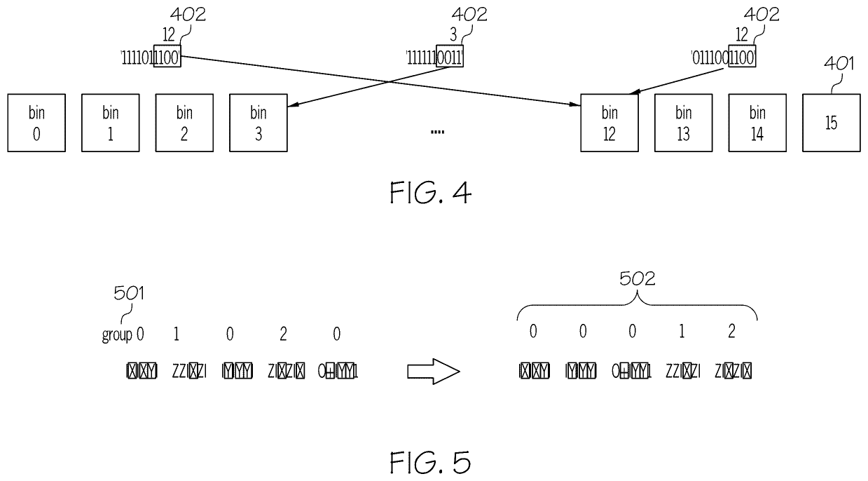

For example, for a sub-string of length=bin_width, there are 2^{bin_width} bins (integers) into which strings of arbitrary length can be sorted. For instance, if there are bit-strings of length 10, and a bin_width of 4, then there are 24=16 possible bins 401 as illustrated in FIG. 4.

FIG. 4 illustrates an efficient procedure to reduce the cost of the subspace search in accordance with an embodiment of the present disclosure.

Referring to FIG. 4, the last 4 digits (see element 402) of the bit-string, corresponding to the bin_width of 4, are utilized to determine which bin 401 such a bit-string is stored. For instance, for the bit-string of 1111011100, the last 4 bits (binary value of 1100) correspond to the value of 12. As a result, such a bit-string is stored in bin #12. In another example, for the bit-string of 1111110011, the last 4 bits (binary value of 0011) correspond to the value of 3. As a result, such a bit-string is stored in bin #3. In a further example, for the bit-string of 0111001100, the last 4 bits (binary value of 1100) correspond to the value of 12. As a result, such a bit-string is stored in bin #12.

As a result of grouping the bit-strings of subspace 302 into bins 401, computation engine 203 may simply analyze a sub-string of the bit-string corresponding to the bin_width, such as the last number of bits corresponding to the bin_width, to determine if the column bit-string is located in subspace 302.

In one embodiment, computation engine 203 further reduces the lookup cost by grouping the terms in the Hamiltonian if they share the same nonzero column bit-string thereby avoiding the lookup procedure for the column bit-string. For example, the following Pauli strings share the same nonzero column bit-string for a given input row: IXIXYI, IYIYYI, 0+IYY1, where + is the tensor product operation, and where 0=|0><0|, 1=|1><1|, and +=a⁺, which represents the creation operator for a qubit (represented by the Pauli X operator). For instance, the X and Y Pauli operators and the + tensor product operation all share the same column value for a given input row.

In one embodiment, computation engine 203 labels each term in the Hamiltonian according to a specific non-diagonal pattern group and then sorts the Hamiltonian terms based on the labeled non-diagonal pattern groups as illustrated in FIG. 5.

FIG. 5 illustrates reducing the lookup cost by classifying each term in the Hamiltonian to a specific non-diagonal group and sorting the Hamiltonian terms based on the designated non-diagonal groups in accordance with an embodiment of the present disclosure.

As shown in FIG. 5, the Pauli strings IXIXYI, IYIYYI, and 0+IYY1 are classified as belonging to the same non-diagonal pattern group 501 assigned the integer value of 0 due to having the pattern of non-diagonal operator, diagonal operator, non-diagonal operator, diagonal operator, diagonal operator, and non-diagonal operator, where X, Y, and + are designated as diagonal operators (operator that has nonzero elements outside of the main diagonal). The Pauli string ZZIXZI is classified as belonging to the non-diagonal pattern group 501 assigned the integer value of 1 due to having the pattern of non-diagonal operator, non-diagonal operator, non-diagonal operator, diagonal operator, non-diagonal operator, and non-diagonal operator. The Paul string ZIXZIX is classified as belonging to the non-diagonal pattern group 501 assigned the integer value of 2 due to having the pattern of non-diagonal operator, non-diagonal operator, diagonal operator, non-diagonal operator, non-diagonal operator, and diagonal operator.

The Paul strings may then be sorted based on the designated non-designated pattern groups (i.e., based on the integer values of the non-diagonal pattern groups 501) as shown by element 502. For example, those Pauli strings that belong to the non-diagonal pattern group 501 assigned the integer value of 0 are listed first followed by those Pauli strings that belong to the non-diagonal pattern group 501 assigned the integer value of 1 followed by those Pauli strings that belong to the non-diagonal pattern group 501 assigned the integer value of 2 as shown by element 502.

It is noted that diagonal operators can be grouped together and the resulting vector can be pre-computed.

In one embodiment, computation engine 203 identifies the qubit position where the operator acting on that qubit is non-diagonal (has off-diagonal elements) and then flips the corresponding bit in the row bit-string. The resulting flipped bit in the column bit-string will represent a nonzero element in the matrix at the corresponding row and column position because the non-diagonal element in the operator effectively “encodes” a nonzero value in the column at that specific position when applied to the row state. That is, by applying a non-diagonal operator to a qubit in a row bit-string, the corresponding bit in the resulting column bit-string is effectively flipped “marking” a nonzero element in that column of the matrix. The resulting flipped bit in the column bit-string will represent a nonzero element in the matrix because the non-diagonal operator introduces a change in the state of the qubit, which translates to a flip in the corresponding bit.

In one embodiment, when representing a matrix using qubits, each row and column of the matrix corresponds to a bit-string. The value at a specific position in the matrix is encoded in the overlap between the corresponding row and column bit-strings.

In one embodiment, a non-diagonal operator, as used herein, is an operator that, when represented as a matrix, has nonzero elements outside of the main diagonal. In one embodiment, the non-diagonal operator represents an operation that can change the state of the qubit from one basis state to another (e.g., |0> to |1> or vice-versa).

In one embodiment, flipping bits, as used herein, refers to changing the value of the bit in the bit-string from 0 to 1 or vice-versa.

In one embodiment, the non-diagonal operator is identified by determining which qubit in the quantum system is acted upon by the non-diagonal operator and then identifying the corresponding position in the row and column bit-strings.

In one embodiment, in the row bit-string, computation engine 203 flips the bit at the position corresponding to the non-diagonal operator. In one embodiment, computation engine 203 analyzes the flipped bit in the column bit-string. If it is “1,” then the element at that position in the column matrix is nonzero. Otherwise, the element is zero.

Referring to the above example where the action of the qubit Hamiltonian on the subspace (e.g. subspace 302) is defined by the set of bit-strings returned from quantum computer 101 as shown below:

$$H = IZZI + IXZZ - IYXZ … ,$$

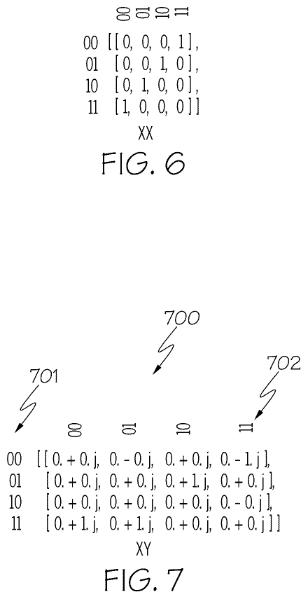

the nonzero columns are given by flipping the bits in the row bit-string as shown below: SSSS, SFSS, SFFS, . . .
where “S” means the same, and “F” means flipping the bit in the row bit-string. Since Pauli operators I and Z are diagonal and Pauli operators X and Y are non-diagonal, in one embodiment, the bits in the row string on the qubits for Pauli operators X and Y are flipped as shown above. An example of flipping the bits is illustrated in FIG. 6.

FIG. 6 illustrates flipping the bits in a bit-string corresponding to a row of the represented matrix on a qubit where an operator is non-diagonal to identify a nonzero element in a bit-string corresponding to a column of the represented matrix in accordance with an embodiment of the present disclosure.

As shown in FIG. 6, flipping the bits 00 corresponds to 11 as indicated by a value of “1” for the row of “00” and column of “11.” Flipping the bits 01 corresponds to 10 as indicated by a value of “1” for the row “01” and column of “10” and so forth.

In one embodiment, computation engine 203 obtains a numerical value for the identified nonzero element from the row and column bit-strings. In one embodiment, computation engine 203 obtains the numerical value for the identified nonzero element from the row and column bit-strings by performing a bitwise AND operation between the row and column bit-strings. The resulting nonzero bit position in the AND result directly corresponds to the numerical value of the identified element in the column bit-string.

In one embodiment, computation engine 203 obtains the numerical value for the identified nonzero element from the row and column bit-strings as well as the 2×2 matrices for the operators in the row and column bit-strings (e.g., projection operators, ladder operators, and/or Pauli operators).

For example, in one embodiment, Pauli operator Z is represented by the values [[1, 0], [0, −1]], Pauli operator X is represented by the values [[0, 1], [1, 0]], and Pauli operator Y is represented by the values [0, −1j], [1j, 0].

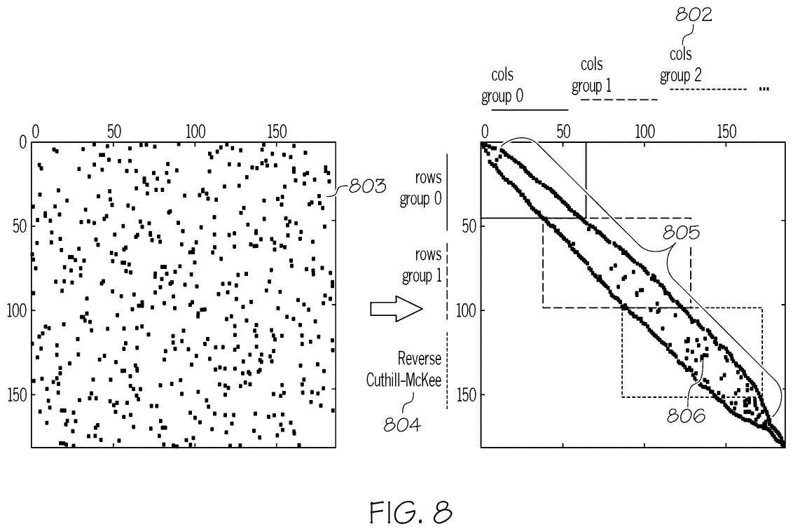

Referring now to FIG. 7, FIG. 7 illustrates obtaining the numerical value of the nonzero element from the row and column bit-strings and the 2×2 matrices for the operators in the Pauli string in accordance with an embodiment of the present disclosure.

As shown in FIG. 7, 2×2 matrix 700 of non-diagonal Pauli operators XY includes a listing of values of the nonzero elements obtained directly from the row and column bit-strings, where element 701 represents the row bit-strings and element 702 represents the column bit-strings. For example, for the row bit-string of 01 for XY, both bits are flipped resulting in the column bit-string of 10. As illustrated in FIG. 7, the value of the nonzero element for such a row and column bit-string is 1j as shown by the following:

$$value = X [ row [ 0 ] , col [ 1 ] ] * Y [ row [ 1 ] , col [ 0 ] ] = X [ 0 , 1 ] * Y [ 1 , 0 ] = 1 * 1 j = 1 j$$

$$value = values [ 4 * 1 + ( 2 * row [ 0 ] + col [ 0 ] ] ) ] * values [ 4 * 2 + ( 2 * row [ 1 ] + col [ 1 ] ] ) ] = value [ 4 + 1 ] * values [ 8 + 2 ] = 1 * 1 j = 1 j$$

In one embodiment, computation engine 203 utilizes various software tools for obtaining such a numerical value including, but not limited to, Matlab®, SciPy®, etc.

In one embodiment, the numerical value for the identified nonzero element is used in mapping Fermionic operators to qubit operators.

An example pseudo code for implementing the above-discussed process for evaluating the action of a Hamiltonian on a subspace (e.g., subspace 302) in a matrix-free manner is shown below: for row_idx, row in [symbol] :
for term in Hamiltonian:

(column,val)=get_col_and_value(term,row)
if column in [symbol] :

col_idx=get_column_idx(column, [symbol] )

out_vector[row_idx]+=in_vector[col_idx]*val*term·coefficient
where [symbol] represents the subspace, and the in-vector and the out-vector are the input and output vectors, respectively.

In one embodiment, such a pseudo code may be implemented for any linear combination or terms with Pauli operators, projection operators, and ladder operators.

In one embodiment, the operations discussed above in connection with Pauli operators can be replaced with non-Pauli operators, such as projection operators and ladder operators, where the ladder operators represent the non-diagonal operators and the projection operators represent the diagonal operators discussed above. In such an embodiment, a zero element in the bit-string corresponding to a column of the represented matrix may be identified.

In one embodiment, since the above-described process for evaluating the action of a Hamiltonian on a subspace (e.g., subspace 302) in a matrix-free manner does not have to convert to a sum of Paul terms when mapping from Fermion to qubit operators, the number of terms in the Jordan-Wigner mapping is equal or greatly reduced thereby improving computational efficiency.

Furthermore, in one embodiment, the above-described process may be implemented using Fermionic operators provided that indices are not repeated. For example, the above-described process may be utilized in the transformations from Fermionic to Bosonic operators. For instance,

$${f}_{p} \to \frac{1}{2} ( {X}_{p} + i {Y}_{p} ) ⊗ {Z}_{p - 1} ⊗ … ⊗ {Z}_{0}$$

corresponds to the transformation of a Fermionic operator in a standard manner using the Jordan-Wigner transformation. Using the above-described process of the present disclosure, such a transformation corresponds to the following:

$${f}_{p} \to {a}_{p} ⊗ {Z}_{p - 1} ⊗ … ⊗ {Z}_{0}$$

where aₚ corresponds to the Bosonic lowering operator which results in a reduction in the terms to compute the Fermionic system as illustrated below.

For example,

$${f}_{1}^{+} {f}_{0} \to \frac{1}{4} [ XX + YY + 1 j \cdot XY - 1 j \cdot YX ]$$

computed in the standard manner requires 4 terms. However, using the above-described process of the present disclosure,

$${f}_{1}^{+} {f}_{0} \to {a}_{1}^{+} {a}_{0}$$

only requires 1 term in the transformation of a Fermionic operator using the Jordan-Wigner transformation.

As a result of the foregoing, the above-described process reduces the number of terms in the Bosonic Hamiltonian generated from the transformation, such as the Jordan-Wigner transformation.

Additionally, in one embodiment, large-scale eigensolving routines support the matrix-free method of the present disclosure. For example, SciPy® supports matrix-free eigensolving via the scipy.sparse.eigs routine that uses ARPACK. Other examples include SLEPc via PETSC.

Furthermore, in one embodiment, the above-described process involving sparse matrix-vector multiplication may be implemented in a distributed manner in which the computations are distributed across various nodes from a first node where such computations are then combined and sent back to the first node. In one embodiment, the amount of data that needs to be distributed can be reduced by reducing the bandwidth and profile of the matrix. In one embodiment, the bandwidth and profile of the matrix is reduced by permutating the rows and columns of the matrix to minimize the bandwidth. As a result, sub-sets of the subspace data that need to be distributed can be identified as illustrated in FIG. 8.

FIG. 8 illustrates matrix permutation that allows for partitioning of the subspace into smaller sub-components that can be distributed for massively-parallel computations in accordance with an embodiment of the present disclosure.

Referring to FIG. 8, FIG. 8 illustrates permutating the rows (see element 801) and columns (see element 802) of the matrix (sparse matrix) of the subspace data 803 to minimize the bandwidth, such as by utilizing the reverse Cuthill-McKee algorithm 804. That is, by utilizing such an algorithm, the sparse matrix (matrix where the majority of its elements are zero) is permutated into a band matrix form 805 with a small bandwidth. As a result, sub-sets 806 of the subspace data 803 that need to be distributed can be identified.

As a result of the foregoing, the principles of the present disclosure evaluate the action of a Hamiltonian on a subspace (e.g., subspace 302) in a matrix-free manner. Furthermore, as discussed herein, the system for performing Fermionic to qubit transformation include projection operators and/or ladder operators that allow for more compact descriptions than solely using Pauli operators.

Furthermore, the principles of the present disclosure provide an efficient means for computing the action of the Hamiltonian onto a vector describing a subspace (e.g., subspace 302) spanned by the bit-strings returned by quantum computer 101. Additionally, the Fermionic and Bosonic operator representations are unified into a single framework for numerical evaluation that does not incur a large overhead as in the Pauli-term transformations.

A further description of these and other functions is provided below in connection with the discussion of the method for evaluating the action of a Hamiltonian on a subspace, such as a subspace of the full Hilbert space, in a matrix-free manner.

Prior to the discussion of the method for evaluating the action of a Hamiltonian on a subspace, such as a subspace of the full Hilbert space, in a matrix-free manner, a description of the hardware configuration of classical computer 102 (FIG. 1) is provided below in connection with FIG. 9.

Referring now to FIG. 9, in conjunction with FIG. 1, FIG. 9 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code 901 involved in performing the inventive methods, such as evaluating the action of a Hamiltonian on a subspace, such as a subspace of the full Hilbert space, in a matrix-free manner. In addition to block 901, computing environment 900 includes, for example, classical computer 102, network 113, such as a wide area network (WAN), end user device (EUD) 902, remote server 903, public cloud 904, and private cloud 905. In this embodiment, classical computer 102 includes processor set 906 (including processing circuitry 907 and cache 908), communication fabric 909, volatile memory 910, persistent storage 911 (including operating system 912 and block 901, as identified above), peripheral device set 913 (including user interface (UI) device set 914, storage 915, and Internet of Things (IoT) sensor set 916), and network module 917. Remote server 903 includes remote database 918. Public cloud 904 includes gateway 919, cloud orchestration module 920, host physical machine set 921, virtual machine set 922, and container set 923.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 918. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically classical computer 102, to keep the presentation as simple as possible. Classical computer 102 may be located in a cloud, even though it is not shown in a cloud in FIG. 9. On the other hand, classical computer 102 is not required to be in a cloud except to any extent as may be affirmatively indicated.

Processor set 906 includes one, or more, computer processors of any type now known or to be developed in the future. Processing circuitry 907 may be distributed over multiple packages, for example, multiple, coordinated integrated circuit chips. Processing circuitry 907 may implement multiple processor threads and/or multiple processor cores. Cache 908 is memory that is located in the processor chip package(s) and is typically used for data or code that should be available for rapid access by the threads or cores running on processor set 906. Cache memories are typically organized into multiple levels depending upon relative proximity to the processing circuitry. Alternatively, some, or all, of the cache for the processor set may be located “off chip.” In some computing environments, processor set 906 may be designed for working with qubits and performing quantum computing.

Computer readable program instructions are typically loaded onto classical computer 102 to cause a series of operational steps to be performed by processor set 906 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 908 and the other storage media discussed below. The program instructions, and associated data, are accessed by processor set 906 to control and direct performance of the inventive methods. In computing environment 900, at least some of the instructions for performing the inventive methods may be stored in block 901 in persistent storage 911.

Communication fabric 909 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 910 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 910 is located in a single package and is internal to classical computer 102, but, alternatively or additionally, the volatile memory may be distributed over multiple packages and/or located externally with respect to classical computer 102.

Persistent Storage 911 is any form of non-volatile storage for computers that is now known or to be developed in the future. The non-volatility of this storage means that the stored data is maintained regardless of whether power is being supplied to classical computer 102 and/or directly to persistent storage 911. Persistent storage 911 may be a read only memory (ROM), but typically at least a portion of the persistent storage allows writing of data, deletion of data and re-writing of data. Some familiar forms of persistent storage include magnetic disks and solid state storage devices. Operating system 912 may take several forms, such as various known proprietary operating systems or open source Portable Operating System Interface type operating systems that employ a kernel. The code included in block 901 typically includes at least some of the computer code involved in performing the inventive methods.

Peripheral device set 913 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 914 may include components such as a display screen, speaker, microphone, wearable devices (such as goggles and smart watches), keyboard, mouse, printer, touchpad, game controllers, and haptic devices. Storage 915 is external storage, such as an external hard drive, or insertable storage, such as an SD card. Storage 915 may be persistent and/or volatile. In some embodiments, storage 915 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 916 is made up of sensors that can be used in Internet of Things applications. For example, one sensor may be a thermometer and another sensor may be a motion detector.

Network module 917 is the collection of computer software, hardware, and firmware that allows classical computer 102 to communicate with other computers through WAN 113. Network module 917 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 917 are performed on the same physical hardware device. In other embodiments (for example, embodiments that utilize software-defined networking (SDN)), the control functions and the forwarding functions of network module 917 are performed on physically separate devices, such that the control functions manage several different network hardware devices. Computer readable program instructions for performing the inventive methods can typically be downloaded to classical computer 102 from an external computer or external storage device through a network adapter card or network interface included in network module 917.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 902 is any computer system that is used and controlled by an end user (for example, a customer of an enterprise that operates classical computer 102), and may take any of the forms discussed above in connection with classical computer 102. EUD 902 typically receives helpful and useful data from the operations of classical computer 102. For example, in a hypothetical case where classical computer 102 is designed to provide a recommendation to an end user, this recommendation would typically be communicated from network module 917 of classical computer 102 through WAN 113 to EUD 902. In this way, EUD 902 can display, or otherwise present, the recommendation to an end user. In some embodiments, EUD 902 may be a client device, such as thin client, heavy client, mainframe computer, desktop computer and so on.

Remote server 903 is any computer system that serves at least some data and/or functionality to classical computer 102. Remote server 903 may be controlled and used by the same entity that operates classical computer 102. Remote server 903 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 918 of remote server 903.

Public cloud 904 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 904 is performed by the computer hardware and/or software of cloud orchestration module 920. The computing resources provided by public cloud 904 are typically implemented by virtual computing environments that run on various computers making up the computers of host physical machine set 921, which is the universe of physical computers in and/or available to public cloud 904. The virtual computing environments (VCEs) typically take the form of virtual machines from virtual machine set 922 and/or containers from container set 923. It is understood that these VCEs may be stored as images and may be transferred among and between the various physical machine hosts, either as images or after instantiation of the VCE. Cloud orchestration module 920 manages the transfer and storage of images, deploys new instantiations of VCEs and manages active instantiations of VCE deployments. Gateway 919 is the collection of computer software, hardware, and firmware that allows public cloud 904 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 905 is similar to public cloud 904, except that the computing resources are only available for use by a single enterprise. While private cloud 905 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 904 and private cloud 905 are both part of a larger hybrid cloud.

Block 901 further includes the software components discussed above in connection with FIGS. 2-8 to evaluate the action of a Hamiltonian on a subspace, such as a subspace of the full Hilbert space, in a matrix-free manner. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for evaluating the action of a Hamiltonian on a subspace, such as a subspace of the full Hilbert space, in a matrix-free manner, may be embodied in an application-specific integrated circuit.

As stated above, in quantum computing, a Hamiltonian (represented by the symbol “H”) is a mathematical operator that represents the total energy of a quantum system, such as the sum of kinetic and potential energies within the quantum system. That is, the Hamiltonian calculates how the quantum system will change over time by defining its energy state. Determining the Hamiltonian of the quantum system is crucial for understanding how qubits (fundamental units of information in quantum computing) evolve and interact within a quantum circuit (collection of interconnected quantum gates, which are used to carry out unitary transformations on qubits). The Hamiltonian is expressed as a matrix in quantum computing, which consists of operators representing both the kinetic energy (“T”) and potential energy (“V”) of the system, where H=T+V. An operator refers to a mathematical object that represents a transformation applied to a quantum state, such as performing a calculation or manipulation on the qubit(s) by changing their superposition and phase to describe a physical property, such as position or momentum, within the quantum system. Typically, the Hamiltonian is expressed using Pauli operators. By using combinations of Pauli operators (e.g., X, Y, and Z), the quantum system's Hamiltonian can be represented in a manner that is easily understood and implemented on the quantum system. Pauli operators, such as the X, Y, and Z operators, are a set of operators used in quantum mechanics that represent measurements of a qubit's spin along the x, y, and z-axis, respectively. Each Pauli operator is represented by a 2×2 matrix. Such an expressed Hamiltonian is utilized in various algorithms. For example, Pauli matrices are used to represent the basic building blocks of fermionic operators (mathematical operators used in quantum mechanics to represent the creation or annihilation of fermionic particles, which are particles that obey the Pauli exclusion principle, referring to having only one fermion occupy a given quantum state at a time) within a qubit system allowing for the translation of a fermionic Hamiltonian (mathematical operator used in quantum mechanics to describe the energy of a system composed of fermionic particles) into a qubit Hamiltonian (outlining how the qubit's quantum state evolves over time) through a specific mapping scheme, such as the Jordan-Wigner transformation. Unfortunately, by utilizing only Pauli operators in such a translation, an unfavorable overhead results, such as in the Jordan-Wigner mapping due to the significant number of operator terms. Furthermore, by operating on Hamiltonians using Pauli operators, computationally expensive matrix operations are required. If, however, the action of Hamiltonians in quantum computing could be evaluated in a matrix-free manner, then such computationally expensive matrix operations could be lessened or avoided in algorithms using the Hamiltonian, such as eigensolving, matrix-exponentiation, and iterative linear solution methods (e.g., Harrow-Hassidim-Lloyd algorithm).

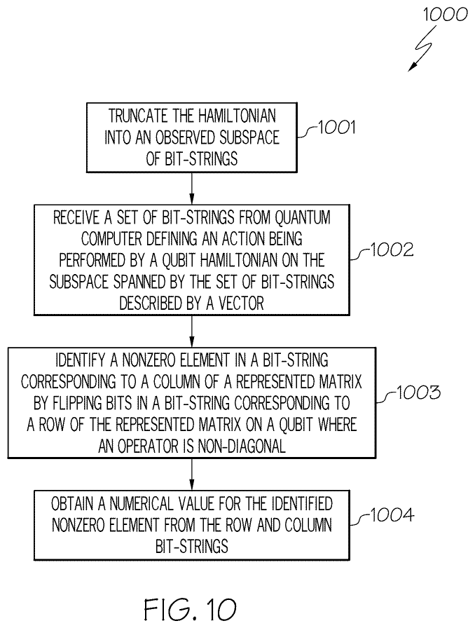

The embodiments of the present disclosure provide the means for evaluating the action of a Hamiltonian on a subspace, such as a subspace of the full Hilbert space, in a matrix-free manner thereby avoiding computationally expensive matrix operations as discussed below in connection with FIG. 10.

FIG. 10 is a flowchart of a method 1000 for evaluating the action of a Hamiltonian on a subspace, such as a subspace of the full Hilbert space, in a matrix-free manner in accordance with an embodiment of the present disclosure.

Referring to FIG. 10, in conjunction with FIGS. 1-9, in step 1001, truncation engine 201 truncates the Hamiltonian into an observed subspace of bit-strings, such as illustrated in FIG. 3.

As discussed above, a subspace, as used herein, refers to a subset of the full Hilbert space which itself forms a smaller Hilbert space. The full Hilbert space, as used herein, refers to the Hilbert space (vector space equipped with an inner product operation, which allows lengths and angles to be defined) with an infinite number of dimensions thereby representing an infinite range of possible states within the quantum system.

Referring to FIG. 3, the Hamiltonian is truncated into an observed subspace of bit-strings from the Hilbert space 301 of 2^{N} qubits, where N is a positive integer number, where each bit-string represents a unique k-element subset, resulting in a subspace 302 of k-elements.

Due to the size of the full Hilbert space, it may be impractical to solve the problem over the full Hilbert space. As a result, the problem may be solved over a polynomial subspace (e.g., subspace 302).

In one embodiment, quantum circuit 109 samples the k-elements of subspace 302 (polynomial set of bit-strings) to define the action being performed by a qubit Hamiltonian on subspace 302 spanned by the set of bit-strings described by a vector.

In one embodiment, a bit-string of length k can be used to represent a subset of a k-element set, with each bit position corresponds to an element and a ‘1’ indicates that the element is included in the subset.

In one embodiment, the Hamiltonian is truncated into a subspace by selecting a subset of k-elements from the full Hilbert space and then projecting the Hamiltonian onto that subspace.

In one embodiment, each of the bit-strings includes a set of operators defining measurement outcomes for a set of qubits. In one embodiment, each bit in the bit-string corresponds to the result of a measurement on a single qubit with “0” or “1” representing the measurement outcome based on the specific operator used.

In one embodiment, Pauli operators (e.g., X, Y, and Z) are used to represent the basis for measuring a qubit. When multiple Pauli operators are combined using tensor products, they define measurement outcomes for a set of qubits which translates directly to a set of bit-strings returned from quantum computer 101 after measurement. In one embodiment, each bit in the bit-string corresponds to the result of a Pauli measurement on a single qubit with a “0” or a “1” representing the measurement outcome based on the specific Pauli measurement used.

In one embodiment, each Pauli operator (e.g., X, Y, and Z) represents a different way to measure a single qubit allowing information about its state along a specific axis in the Bloch sphere to be extracted. When multiple qubits are measured, Pauli operators are combined using tensor products creating a Pauli string that defines the combined measurement outcome for all qubits involved.

In one embodiment, the result of the Pauli measurement on each qubit is either “0” or “1” so the entire set of Pauli measurements on multiple qubits translates to a bit-string where each bit in the bit-string represents the measurement outcome of a single qubit.

In step 1002, receiving engine 202 receives a set of bit-strings from quantum computer 101 defining an action being performed by a qubit Hamiltonian on the subspace (observed subspace of bit-strings discussed above in step 1001) (e.g., subspace 302) spanned by the set of bit-strings described by a vector. That is, the action of a subspace Hamiltonian is applied to a vector, which may be equal to the subspace (e.g., subspace 302) of the full Hilbert space (e.g., Hilbert space 301), in a matrix-free manner thereby allowing for efficient computation of quantities, such as the eigenspectrum of the Hamiltonian confined to the subspace.

As stated above, a qubit Hamiltonian, as used herein, refers to a mathematical operator that represents the total energy of a single qubit. In one embodiment, the vector (e.g., matrix-vector product) is equal to the subspace (e.g., subspace 302) of the full Hilbert space (e.g., Hilbert space 301). In one embodiment, the vector is represented as a column matrix (one column and as many rows as the number of elements in the vector), which is multiplied by a matrix, where the matrix has the same number of columns as the vector has elements.

In one embodiment, the subspace of bit-strings (e.g., subspace 302) is described by the vector where each element in the vector corresponds to the value of the bit in a bit-string in the subspace (e.g., subspace 302).

An example of a set of bit-strings defining an action being performed by a qubit Hamiltonian on a subspace (e.g., subspace 302) spanned by the set of bit-strings is shown below:

H=IZZI+IXZZ−IYXZ . . .
where Pauli operator X represents a bit flip operation, Pauli operator Y performs a combination of a bit flip and a phase flip on a qubit, Pauli operator Z applies a phase flip to a qubit, leaving the state |0> unchanged and adding a negative phase to |1>, and Pauli operator I is the identity operator, which performs the “do nothing” operation that leaves the quantum state unchanged.

While the foregoing illustrates a Pauli string (bit-string that includes a set of Pauli operators), such a string may include a set of operators, such as projection operators and/or ladder operators, defining the measurement outcomes for a set of qubits. In one embodiment, the set of operators may also include Pauli operators in combination with projection operators and/or ladder operators.

In one embodiment, each bit-string in the received set of bit-strings has one nonzero element per row of a represented matrix. A represented matrix, as used herein, refers to a matrix that is representative of the action of the qubit Hamiltonian on the subspace (e.g., subspace 302).

In step 1003, computation engine 203 identifies a nonzero element in a bit-string corresponding to a column of the represented matrix (“column bit-string”) by flipping bits in a bit-string corresponding to a row of the represented matrix (“row bit-string”) on a qubit where an operator is non-diagonal, where the column and row bit-strings are included in the received set of bit-strings.

As discussed above, in one embodiment, computation engine 203 performs a search in subspace 302 to identify the column bit-string in subspace 302. In one embodiment, computation engine 203 iterates through subspace 302 to identify a column bit-string in subspace 302.

In one embodiment, computation engine 203 groups the bit-strings of subspace 302 into “bins” that are determined by the integer value of a sub-string of a variable width (referred to herein as the “bin_width”).

For example, for a sub-string of length=bin_width, there are 2^{bin_width} bins (integers) into which strings of arbitrary length can be sorted. For instance, if there are bit-strings of length 10, and a bin_width of 4, then there are 24=16 possible bins 401 as illustrated in FIG. 4.

Referring to FIG. 4, the last 4 digits (see element 402) of the bit-string, corresponding to the bin_width of 4, are utilized to determine which bin 401 such a bit-string is stored. For instance, for the bit-string of 1111011100, the last 4 bits (binary value of 1100) correspond to the value of 12. As a result, such a bit-string is stored in bin #12. In another example, for the bit-string of 1111110011, the last 4 bits (binary value of 0011) correspond to the value of 3. As a result, such a bit-string is stored in bin #3. In a further example, for the bit-string of 0111001100, the last 4 bits (binary value of 1100) correspond to the value of 12. As a result, such a bit-string is stored in bin #12.

As a result of grouping the bit-strings of subspace 302 into bins 401, computation engine 203 may simply analyze a sub-string of the bit-string corresponding to the bin_width, such as the last number of bits corresponding to the bin_width, to determine if the column bit-string is located in subspace 302.

In one embodiment, computation engine 203 further reduces the lookup cost by grouping the terms in the Hamiltonian if they share the same nonzero column bit-string thereby avoiding the lookup procedure for the column bit-string. For example, the following Pauli strings share the same nonzero column bit-string for a given input row: IXIXYI, IYIYYI, 0+IYY1, where + is the tensor product operation, and where 0=|0><0|, 1=|1><1|, and +=a⁺, which represents the creation operator for a qubit (represented by the Pauli X operator). For instance, the X and Y Pauli operators and the + tensor product operation all share the same column value for a given input row.

In one embodiment, computation engine 203 labels each term in the Hamiltonian according to a specific non-diagonal pattern group and then sorts the Hamiltonian terms based on the labeled non-diagonal pattern group as illustrated in FIG. 5.

As shown in FIG. 5, the Pauli strings IXIXYI, IYIYYI, and 0+IYY1 are classified as belonging to the same non-diagonal pattern group 501 assigned the integer value of 0 due to having the pattern of non-diagonal operator, diagonal operator, non-diagonal operator, diagonal operator, diagonal operator, and non-diagonal operator, where X, Y, and + are designated as diagonal operators (operator that has nonzero elements outside of the main diagonal) . . . . The Pauli string ZZIXZI is classified as belonging to the non-diagonal pattern group 501 assigned the integer value of 1 due to having the pattern of non-diagonal operator, non-diagonal operator, non-diagonal operator, diagonal operator, non-diagonal operator, and non-diagonal operator. The Paul string ZIXZIX is classified as belonging to the non-diagonal pattern group 501 assigned the integer value of 2 due to having the pattern of non-diagonal operator, non-diagonal operator, diagonal operator, non-diagonal operator, non-diagonal operator, and diagonal operator.

The Paul strings may then be sorted based on the designated non-designated pattern groups (i.e., based on the integer values of the non-diagonal pattern groups 501) as shown by element 502. For example, those Pauli strings that belong to the non-diagonal pattern group 501 assigned the integer value of 0 are listed first followed by those Pauli strings that belong to the non-diagonal pattern group 501 assigned the integer value of 1 followed by those Pauli strings that belong to the non-diagonal pattern group 501 assigned the integer value of 2 as shown by element 502.

It is noted that diagonal operators can be grouped together and the resulting vector can be pre-computed.

In one embodiment, computation engine 203 identifies the qubit position where the operator acting on that qubit is non-diagonal (has off-diagonal elements) and then flips the corresponding bit in the row bit-string. The resulting flipped bit in the column bit-string will represent a nonzero element in the matrix at the corresponding row and column position because the non-diagonal element in the operator effectively “encodes” a nonzero value in the column at that specific position when applied to the row state. That is, by applying a non-diagonal operator to a qubit in a row bit-string, the corresponding bit in the resulting column bit-string is effectively flipped “marking” a nonzero element in that column of the matrix. The resulting flipped bit in the column bit-string will represent a nonzero element in the matrix because the non-diagonal operator introduces a change in the state of the qubit, which translates to a flip in the corresponding bit.

In one embodiment, when representing a matrix using qubits, each row and column of the matrix corresponds to a bit-string. The value at a specific position in the matrix is encoded in the overlap between the corresponding row and column bit-strings.

In one embodiment, a non-diagonal operator, as used herein, is an operator that, when represented as a matrix, has nonzero elements outside of the main diagonal. In one embodiment, the non-diagonal operator represents an operation that can change the state of the qubit from one basis state to another (e.g., |0> to |1> or vice-versa).

In one embodiment, flipping bits, as used herein, refers to changing the value of the bit in the bit-string from 0 to 1 or vice-versa.

In one embodiment, the non-diagonal operator is identified by determining which qubit in the quantum system is acted upon by the non-diagonal operator and then identifying the corresponding position in the row and column bit-strings.

In one embodiment, in the row bit-string, computation engine 203 flips the bit at the position corresponding to the non-diagonal operator. In one embodiment, computation engine 203 analyzes the flipped bit in the column bit-string. If it is “1,” then the element at that position in the column matrix is nonzero. Otherwise, the element is zero.

Referring to the above example where the action of the qubit Hamiltonian on the subspace (e.g. subspace 302) is defined by the set of bit-strings returned from quantum computer 101 as shown below:

$$H = IZZI + IXZZ - IYXZ … ,$$

the nonzero columns are given by flipping the bits in the row bit-string as shown below:
SSSS, SFSS, SFFS, . . .
where “S” means the same, and “F” means flipping the bit in the row bit-string. Since Pauli operators I and Z are diagonal and Pauli operators X and Y are non-diagonal, in one embodiment, the bits in the row string on the qubits for Pauli operators X and Y are flipped as shown above. An example of flipping the bits is illustrated in FIG. 6.

As shown in FIG. 6, flipping the bits 00 corresponds to 11 as indicated by a value of “1” for the row of “00” and column of “11.” Flipping the bits 01 corresponds to 10 as indicated by a value of “1” for the row “01” and column of “10” and so forth.

In step 1004, computation engine 203 obtains a numerical value for the identified nonzero element from the row and column bit-strings.

As stated above, in one embodiment, computation engine 203 obtains the numerical value for the identified nonzero element from the row and column bit-strings by performing a bitwise AND operation between the row and column bit-strings. The resulting nonzero bit position in the AND result directly corresponds to the numerical value of the identified element in the column bit-string.

In one embodiment, computation engine 203 obtains the numerical value for the identified nonzero element from the row and column bit-strings as well as the 2×2 matrices for the operators in the row and column bit-strings (e.g., projection operators, ladder operators, and/or Pauli operators).

For example, in one embodiment, Pauli operator Z is represented by the values [[1, 0], [0, −1]], Pauli operator X is represented by the values [[0, 1], [1, 0]], and Pauli operator Y is represented by the values [[0, −1j], [1j, 0]].

Referring to FIG. 7, 2×2 matrix 700 of non-diagonal Pauli operators XY includes a listing of values of the nonzero elements obtained directly from the row and column bit-strings, where element 701 represents the row bit-strings and element 702 represents the column bit-strings. For example, for the row bit-string of 01 for XY, both bits are flipped resulting in the column bit-string of 10. As illustrated in FIG. 7, the value of the nonzero element for such a row and column bit-string is 1j as shown by the following:

$$value = X [ row [ 0 ] , col [ 1 ] ] * Y [ row [ 1 ] , col [ 0 ] ] = X [ 0 , 1 ] * Y [ 1 , 0 ] = 1 * 1 j = 1 j$$

$$value = values [ 4 * 1 + ( 2 * row [ 0 ] + col [ 0 ] ] ) ] * values [ 4 * 2 + ( 2 * row [ 1 ] + col [ 1 ] ] ) ] = value [ 4 + 1 ] * values [ 8 + 2 ] = 1 * 1 j = 1 j$$

In one embodiment, computation engine 203 utilizes various software tools for obtaining such a numerical value including, but not limited to, Matlab®, SciPy®, etc.

In one embodiment, the numerical value for the identified nonzero element is used in mapping Fermionic operators to qubit operators.

An example pseudo code for implementing the above-discussed process for evaluating the action of a Hamiltonian on a subspace (e.g., subspace 302) in a matrix-free manner is shown below:

for row_idx, row in [symbol] :
for term in Hamiltonian:
(column, val) = get_col_and_value(term, row)
if column in [symbol] :
col_idx = get_column_idx(column, [symbol] )
out_vector[row_idx] += in_vector[col_idx] * val * term.coefficient

where [symbol] represents the subspace, and the in-vector and the out-vector are the input and output vectors, respectively.

In one embodiment, such a pseudo code may be implemented for any linear combination or terms with Pauli operators, projection operators, and ladder operators.

In one embodiment, the operations discussed above in connection with Pauli operators can be replaced with non-Pauli operators, such as projection operators and ladder operators, where the ladder operators represent the non-diagonal operators and the projection operators represent the diagonal operators discussed above. In such an embodiment, a zero element in the bit-string corresponding to a column of the represented matrix may be identified.

In one embodiment, since the above-described process for evaluating the action of a Hamiltonian on a subspace (e.g., subspace 302) in a matrix-free manner does not have to convert to a sum of Paul terms when mapping from Fermion to qubit operators, the number of terms in the Jordan-Wigner mapping is equal or greatly reduced thereby improving computational efficiency.

Furthermore, in one embodiment, the above-described process may be implemented using Fermionic operators provided that indices are not repeated. For example, the above-described process may be utilized in the transformations from Fermionic to Bosonic operators. For instance,

$${f}_{p} \to \frac{1}{2} ( {X}_{p} + i {Y}_{p} ) ⊗ {Z}_{p - 1} ⊗ … ⊗ {Z}_{0}$$

corresponds to the transformation of a Fermionic operator in a standard manner using the Jordan-Wigner transformation. Using the above-described process of the present disclosure, such a transformation corresponds to the following:

$${f}_{p} \to {a}_{p} ⊗ {Z}_{p - 1} ⊗ … ⊗ {Z}_{0}$$

where aₚ corresponds to the Bosonic lowering operator which results in a reduction in the terms to compute the Fermionic system as illustrated below.

For example,

$${f}_{1}^{+} {f}_{0} \to \frac{1}{4} [ XX + YY + 1 j \cdot XY - 1 j \cdot YX ]$$

computed in the standard manner requires 4 terms. However, using the above-described process of the present disclosure,

$${f}_{1}^{+} {f}_{0} \to {a}_{1}^{+} {a}_{0}$$

only requires 1 term in the transformation of a Fermionic operator using the Jordan-Wigner transformation.

As a result of the foregoing, the above-described process reduces the number of terms in the Bosonic Hamiltonian generated from the transformation, such as the Jordan-Wigner transformation.

Additionally, in one embodiment, large-scale eigensolving routines support the matrix-free method of the present disclosure. For example, SciPy® supports matrix-free eigensolving via the scipy.sparse.eigs routine that uses ARPACK. Other examples include SLEPc via PETSC.

Furthermore, in one embodiment, the above-described process involving sparse matrix-vector multiplication may be implemented in a distributed manner in which the computations are distributed across various nodes from a first node where such computations are then combined and sent back to the first node. In one embodiment, the amount of data that needs to be distributed can be reduced by reducing the bandwidth and profile of the matrix. In one embodiment, the bandwidth and profile of the matrix is reduced by permutating the rows and columns of the matrix to minimize the bandwidth. As a result, sub-sets of the subspace data that need to be distributed can be identified as illustrated in FIG. 8.

Referring to FIG. 8, FIG. 8 illustrates permutating the rows (see element 801) and columns (see element 802) of the matrix (sparse matrix) of the subspace data 803 to minimize the bandwidth, such as by utilizing the reverse Cuthill-McKee algorithm 804. That is, by utilizing such an algorithm, the sparse matrix (matrix where the majority of its elements are zero) is permutated into a band matrix form 805 with a small bandwidth. As a result, sub-sets 806 of the subspace data 803 that need to be distributed can be identified.

As a result of the foregoing, the principles of the present disclosure evaluate the action of a Hamiltonian on a subspace (e.g., subspace 302) in a matrix-free manner. Furthermore, as discussed herein, the system for performing Fermionic to qubit transformation include projection operators and/or ladder operators that allow for more compact descriptions than solely using Pauli operators.

Furthermore, the principles of the present disclosure provide an efficient means for computing the action of the Hamiltonian onto a vector describing a subspace (e.g., subspace 302) spanned by the bit-strings returned by quantum computer 101. Additionally, the Fermionic and Bosonic operator representations are unified into a single framework for numerical evaluation that does not incur a large overhead as in the Pauli-term transformations.

Furthermore, the principles of the present disclosure improve the technology or technical field involving quantum computing.

As discussed above, in quantum computing, a Hamiltonian (represented by the symbol “H”) is a mathematical operator that represents the total energy of a quantum system, such as the sum of kinetic and potential energies within the quantum system. That is, the Hamiltonian calculates how the quantum system will change over time by defining its energy state. Determining the Hamiltonian of the quantum system is crucial for understanding how qubits (fundamental units of information in quantum computing) evolve and interact within a quantum circuit (collection of interconnected quantum gates, which are used to carry out unitary transformations on qubits). The Hamiltonian is expressed as a matrix in quantum computing, which consists of operators representing both the kinetic energy (“T”) and potential energy (“V”) of the system, where H=T+V. An operator refers to a mathematical object that represents a transformation applied to a quantum state, such as performing a calculation or manipulation on the qubit(s) by changing their superposition and phase to describe a physical property, such as position or momentum, within the quantum system. Typically, the Hamiltonian is expressed using Pauli operators. By using combinations of Pauli operators (e.g., X, Y, and Z), the quantum system's Hamiltonian can be represented in a manner that is easily understood and implemented on the quantum system. Pauli operators, such as the X, Y, and Z operators, are a set of operators used in quantum mechanics that represent measurements of a qubit's spin along the x, y, and z-axis, respectively. Each Pauli operator is represented by a 2×2 matrix. Such an expressed Hamiltonian is utilized in various algorithms. For example, Pauli matrices are used to represent the basic building blocks of fermionic operators (mathematical operators used in quantum mechanics to represent the creation or annihilation of fermionic particles, which are particles that obey the Pauli exclusion principle, referring to having only one fermion occupy a given quantum state at a time) within a qubit system allowing for the translation of a fermionic Hamiltonian (mathematical operator used in quantum mechanics to describe the energy of a system composed of fermionic particles) into a qubit Hamiltonian (outlining how the qubit's quantum state evolves over time) through a specific mapping scheme, such as the Jordan-Wigner transformation. Unfortunately, by utilizing only Pauli operators in such a translation, an unfavorable overhead results, such as in the Jordan-Wigner mapping due to the significant number of operator terms. Furthermore, by operating on Hamiltonians using Pauli operators, computationally expensive matrix operations are required. If, however, the action of Hamiltonians in quantum computing could be evaluated in a matrix-free manner, then such computationally expensive matrix operations could be lessened or avoided in algorithms using the Hamiltonian, such as eigensolving, matrix-exponentiation, and iterative linear solution methods (e.g., Harrow-Hassidim-Lloyd algorithm).

Embodiments of the present disclosure improve such technology by evaluating the Hamiltonians using operators beyond the Pauli operators as discussed above on a classical computer by computing the nonzero elements of the Hamiltonian in a matrix-free manner. In one embodiment, a set of bit-strings from the quantum computer which define an action being performed by a qubit Hamiltonian (a mathematical operator that represents the total energy of a single qubit) on a subspace spanned by the set of bit-strings described by a vector is received. That is, the action of a subspace Hamiltonian is applied to a vector, which may be equal to the subspace of the full Hilbert space, in a matrix-free manner thereby allowing for efficient computation of quantities, such as the eigenspectrum of the Hamiltonian confined to the subspace. A bit-string, as used herein, refers to a sequence of computational basis states of the qubits, where each qubit can be in a superposition state allowing the string to represent a vast range of possibilities. In one embodiment, each of the bit-strings includes a set of operators defining measurement outcomes for a set of qubits. Such operators may include projection operators and/or ladder operators. Furthermore, in one embodiment, such operators include Pauli operators in combination with the projection operators and/or ladder operators. Additionally, in one embodiment, each of the bit-strings has one nonzero element per row of a represented matrix. A represented matrix, as used herein, refers to a matrix that is representative of the action of the qubit Hamiltonian on the subspace. A nonzero element in a bit-string corresponding to a column of the represented matrix is identified by flipping bits in a bit-string corresponding to a row of the represented matrix on a qubit where an operator is non-diagonal. An operator is considered “non-diagonal” when its matrix representation has nonzero entries outside of the main diagonal. A numerical value for the identified nonzero element is then obtained from the row and column bit-strings. In this manner, nonzero elements of a Hamiltonian can be computed in a matrix-free manner, where the explicit formation of a matrix representation is avoided along with the associated floating-point calculations. Using the computational transformation from Fermions, such matrix-free techniques of the present disclosure can be applied to both Fermion and Bosonic problems in a unified manner. Furthermore, in this manner, there is an improvement in the technical field involving quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for computing nonzero elements of a Hamiltonian in a matrix-free manner, the method comprising:
receiving a set of bit-strings from a quantum computer defining an action being performed by a qubit Hamiltonian on a subspace spanned by said set of bit-strings described by a vector, wherein each of said set of bit-strings comprises a set of operators defining measurement outcomes for a set of qubits, wherein each of said set of bit-strings has one nonzero element per row of a represented matrix;
identifying a nonzero element in a bit-string corresponding to a column of said represented matrix by flipping bits in a bit-string corresponding to a row of said represented matrix on a qubit where an operator is non-diagonal; and
obtaining a numerical value for said identified nonzero element from said row and column bit-strings.

2. The method as recited in claim 1, wherein said set of operators comprises projection operators and ladder operators.

3. The method as recited in claim 1, wherein said set of operators comprises Pauli operators.

4. The method as recited in claim 1, wherein said numerical value for said identified nonzero element is obtained from said row and column bit-strings and 2×2 matrices for operators in said row and column bit-strings.

5. The method as recited in claim 1, wherein said numerical value for said identified nonzero element is used in mapping Fermionic operators to qubit operators.

6. The method as recited in claim 1, wherein said action of said qubit Hamiltonian is performed on said subspace of a full Hilbert space.

7. The method as recited in claim 6, wherein a dimension of said vector is equal to said subspace of said full Hilbert space.

8. The method as recited in claim 1, wherein said vector is a matrix-vector product.

9. The method as recited in claim 1 further comprising:
sorting said set of bit-strings in said subspace into bins based on an integer value of a sub-string of said set of bit-strings.

10. The method as recited in claim 1 further comprising:
classifying each term in said qubit Hamiltonian to one of a plurality of designated non-diagonal pattern groups and sorting said Hamiltonian terms based on said plurality of designated non-diagonal pattern groups.

11. The method as recited in claim 1 further comprising:
permutating rows and columns of a sparse matrix of subspace data of said subspace into a band matrix form.

12. A computer program product for computing nonzero elements of a Hamiltonian in a matrix-free manner, the computer program product comprising one or more computer readable storage mediums having program code embodied therewith, the program code comprising programming instructions for:
receiving a set of bit-strings from a quantum computer defining an action being performed by a qubit Hamiltonian on a subspace spanned by said set of bit-strings described by a vector, wherein each of said set of bit-strings comprises a set of operators defining measurement outcomes for a set of qubits, wherein each of said set of bit-strings has one nonzero element per row of a represented matrix;
identifying a nonzero element in a bit-string corresponding to a column of said represented matrix by flipping bits in a bit-string corresponding to a row of said represented matrix on a qubit where an operator is non-diagonal; and
obtaining a numerical value for said identified nonzero element from said row and column bit-strings.

13. The computer program product as recited in claim 12, wherein said set of operators comprises projection operators and ladder operators.

14. The computer program product as recited in claim 12, wherein said set of operators comprises Pauli operators.

15. The computer program product as recited in claim 12, wherein said numerical value for said identified nonzero element is obtained from said row and column bit-strings and 2×2 matrices 2 for operators in said row and column bit-strings.

16. The computer program product as recited in claim 12, wherein said numerical value for said identified nonzero element is used in mapping Fermionic operators to qubit operators.

17. A system, comprising:
a memory for storing a computer program for computing nonzero elements of a Hamiltonian in a matrix-free manner; and
a processor connected to said memory, wherein said processor is configured to execute program instructions of the computer program comprising:
receiving a set of bit-strings from a quantum computer defining an action being performed by a qubit Hamiltonian on a subspace spanned by said set of bit-strings described by a vector, wherein each of said set of bit-strings comprises a set of operators defining measurement 8 outcomes for a set of qubits, wherein each of said set of bit-strings has one nonzero element per row of a represented matrix;
identifying a nonzero element in a bit-string corresponding to a column of said represented matrix by flipping bits in a bit-string corresponding to a row of said represented matrix on a qubit where an operator is non-diagonal; and
obtaining a numerical value for said identified nonzero element from said row and column bit-strings.

18. The system as recited in claim 17, wherein said set of operators comprises projection operators and ladder operators.

19. The system as recited in claim 17, wherein said set of operators comprises Pauli operators.

20. The system as recited in claim 17, wherein said numerical value for said identified nonzero element is obtained from said row and column bit-strings and 2×2 matrices for operators in said row and column bit-strings.
